(19) United States
(12) Patent Application Publication
(10) Pub. No.: US 2012/0144353 A1
(43) Pub. Date: Jun. 7, 2012

(54) Method for Implementing Timing Point Engineering Change Orders in an Integrated Circuit Design Flow

(76) Inventors: Chetan C. Kamdar, Austin, TX (US); Liang Xia, Austin, TX (US)

(21) Appl. No.: 13/155,854

(22) Filed: Jun. 8, 2011

Related U.S. Application Data
(60) Provisional application No. 61/420,173, filed on Dec. 6, 2010.

(51) Int. Cl. G06F 17/50

(52) U.S. Cl. 716/108

(57) ABSTRACT

A method and system for automatically implementing engineering change order (ECO) corrections in an integrated circuit (IC) include a design tool performing a timing analysis on a netlist of the IC. The method may also include annotating each of the device cells with a worst timing slack through a respective timing point associated with the device cell. In addition, the method may include generating an ECO list of device cells needing ECO correction and prioritizing the ECO correction order of the device cells in the ECO list based upon cell attributes. The method may further include excluding device cells in the ECO list based upon the fan-in or fan-out connection path of other device cells in the ECO list that will be corrected, and the design tool selecting and replacing device cells in the ECO list with different device cells from a design library.

This patent application claims priority to Provisional Patent Application Ser. No. 61/420,173, filed Dec. 6, 2010, the content of which is herein incorporated by reference in its entirety.

### BACKGROUND

1. Technical Field

This disclosure relates to integrated circuit design, and more particularly to a method for correcting timing path violations.

2. Description of the Related Art

The design cycle for integrated circuits is complex and there are many steps. During the design cycle there are many timing checks performed to ensure that signal paths meet specified timing. Generally, once the circuit has been synthesized, placed, and routed, changes to the circuit are referred to as engineering change orders or ECOs.

In a typical conventional ECO design flow the static timing path analyzer (STA) may provide a list of timing paths that do not meet timing. The conventional ECO tools may make changes to the problem timing paths in various ways. For example, one or more gates may be swapped to allow the timing path to meet timing. However, in many cases swapping a gate in a timing path of interest may cause unintended consequences in other related timing paths. These conventional ECO tools may repair several timing paths and then have to go back and undo some of the fixes because of the unintended timing problems created in the other paths. This can lead to unacceptably long delays in getting convergence in timing path errors, and thus delays in closure of the design cycle.

### SUMMARY OF THE EMBODIMENTS

Various embodiments of a method and system for automatically implementing engineering change order (ECO) corrections in an integrated circuit (IC) are disclosed. In one embodiment, the method includes a design tool performing a timing analysis for a netlist of the IC that includes a listing of device cells. The method may also include annotating each of the device cells in the listing with a worst timing slack through a respective timing point associated with the device cell. In addition, the method may include generating an ECO list of device cells needing ECO correction and prioritizing the ECO correction order of the device cells in the ECO list based upon cell attributes such as cell size and/or speed for example. The method may further include excluding one or more device cells in the ECO list based upon the fan-in or fan-out connection path of other device cells in the ECO list that will be corrected, and the design tool selecting device cells in the ECO list and replacing the selected device cells in the netlist with different device cells from a design library.

In one specific implementation, the method may further include performing a downstream power analysis to identify devices that have one or more fanout paths that consume power above a predetermined threshold. The method may also include replacing devices that have one or more fanout paths that consume power above the predetermined threshold with a device that has a faster switching speed, and replacing one or more of the devices in the one or more fanout paths with devices that have a slower switching speed.

In another specific implementation, the method may further include performing an upstream power analysis to identify devices that have one or more fan-in paths that consume power above a predetermined threshold. The method may also include replacing devices that have one or more fan-in paths that consume power above the predetermined threshold with a device that has a faster switching speed, and replacing one or more of the devices in the one or more fan-in paths with devices that have a slower switching speed.

### BRIEF DESCRIPTION OF THE DRAWINGS

FIG. 1 is a flow diagram depicting an operational flow for implementing engineering change orders in an integrated circuit design flow.

FIG. 2 is a block diagram of an exemplary logic circuit including a number of timing paths.

FIG. 3 is a block diagram of one embodiment of a computer system used to implement an automated IC design tool.

Specific embodiments are shown by way of example in the drawings and will herein be described in detail. It should be understood, however, that the drawings and detailed description are not intended to limit the claims to the particular embodiments disclosed, even where only a single embodiment is described with respect to a particular feature. On the contrary, the intention is to cover all modifications, equivalents and alternatives that would be apparent to a person skilled in the art having the benefit of this disclosure. Examples of features provided in the disclosure are intended to be illustrative rather than restrictive unless stated otherwise.

As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six, interpretation for that unit/circuit/component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

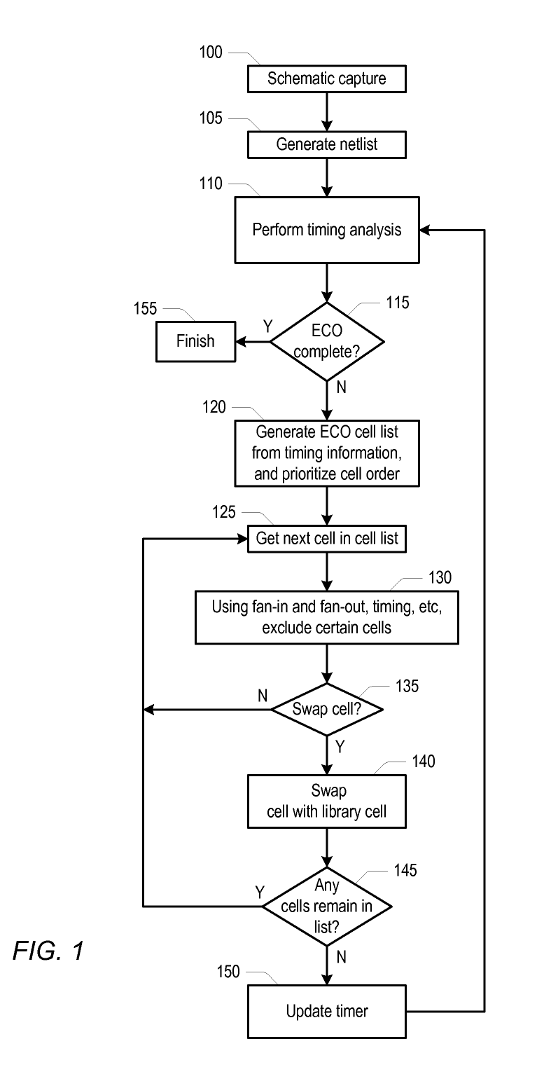

Turning now to FIG. 1, a flow diagram depicting an operational flow for implementing engineering change orders in an integrated circuit design flow. Beginning in block 100, a schematic representation of the integrated circuit is created or synthesized from a hardware description language representation such as RTL, for example. This is sometimes referred to as schematic capture. In addition, the RTL circuit representation may be synthesized into a netlist by a synthesis tool (block 105). The netlist includes a listing of the circuit components and their connectivity. The netlist may also include or refer to descriptions of the circuit components. The netlist may be input to a timing analyzer design tool such as a static timing analysis tool (STA).

The timing analyzer may analyze all clock and data paths in the IC design to ensure that the design meets timing. Depending on the type of analysis, the timing analyzer may take into account all the resistor-capacitor (RC) time constants of the wires, the wire thicknesses, the distances between components, the intrinsic delays of each component, and the like. The timing analyzer may store timing and circuit information in a database. The timing analyzer may generate a timing report that includes a listing of all circuit paths that have timing violations and their associated path delays. In addition, the timing analyzer may annotate the worst timing slack through a timing point on each cell (block 110). Slack typically refers to the difference between the required time and arrival time of the signal propagating on that path, or the amount of “spare” time. If there are no engineering change order (ECO) changes to be made to the circuit based upon the timing information (block 115), the process is complete (block 155).

However, if there are changes to be made (block 115), an ECO cell list may be generated from the timing analyzer information. The ECO cell list includes a listing of possible cells to be operated on. The ECO cell list may be prioritized and ordered based on what the ECO is meant to fix (block 120). For example, the ECO may be fixing setup timing, hold timing, leakage, active power, circuit area, etc. Accordingly, cell attributes such as device size, switching speed, power consumption, and the like may used in the determination of the correction order.

In one embodiment, the ECO cell list generation may use a downstream power cost approach. More particularly, each cell may be analyzed and ranked based upon the amount of power consumed by downstream cells in a given cell's fanout. For example, speeding up a given cell (increasing power for that one cell) that has high downstream power cost may allow a lot of power recovery in other cells because those cells in the downstream fanout may be slowed down to achieve a net power reduction while still allowing a particular timing path to meet timing. Accordingly, timing and power information may be extracted from the timing analysis, the device library, etc. and used to perform the downstream power analysis. In one embodiment, device cells may be identified as having fanout paths that include cells that either by themselves or collectively consume more than some predetermined threshold of power.

In another embodiment, the ECO cell list generation may use an upstream power cost approach, which is similar to the downstream approach. More particularly, each cell may be analyzed and ranked based upon the amount of power consumed by upstream cells in a given cell's fan-in. For example, speeding up a given cell (increasing power for that one cell) that has high upstream power cost may allow a lot of power recovery in other cells because those cells in the upstream fan-in may be slowed down to achieve a net power reduction while still allowing a particular timing path to meet timing. Accordingly, as above timing and power information may be extracted from the timing analysis, the device library, etc. and used to perform the upstream power analysis. In one embodiment, device cells may be identified as having fan-in paths that include cells that either by themselves or collectively consume more than some predetermined threshold of power.

Further, once the ECO cell list has been generated and ordered, the ECO list is accessed, the next cell is retrieved, and is analyzed (block 125) to determine whether it can be modified or swapped out. In one embodiment, a determination may be made as to whether the cell may be swapped out just due to it's own timing etc. The fan-in and fan-out of the cell is also checked to ensure that cells in the list that are in the fan-in and fan-out cone of another cell in the list are not modified (block 130). These cells are excluded or “blacklisted” from being modified until after a timer update is performed. However once the timing analysis is run again, these cells may again be analyzed to determine whether they should and can be modified.

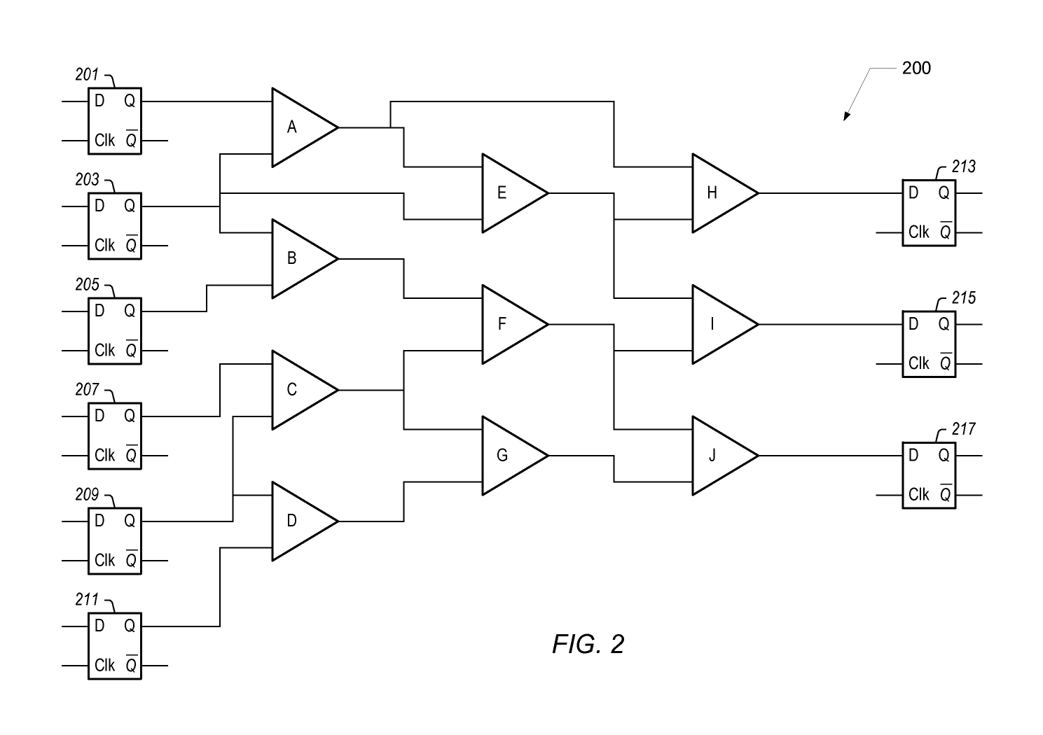

More particularly, in FIG. 2 a block diagram of an exemplary logic circuit including a number of timing paths is shown. The circuit 200 includes several timing paths including several flip-flops (FF). The FFs include FF201-FF217, and logic gates A-J. A first path corresponds to FF 201, gates A, E, and H, and FF 213. A second path includes FF 201, gates A and H and FF213. A third path includes FF201, gates A, E, and I, and FF 215. A fourth path includes FF203, gates A, E, and H, and FF213. A fifth path includes FF203, gates A and H, and FF 213. A sixth path includes FF203, gates E and H, and FF 213. A seventh path includes FF203, gates E and I, and FF215. There are many other such paths through the remaining cells which have not been described here for brevity.

In the circuit 200 of FIG. 2, cells C and J may not both be modified together because they are in each other's fan-in/fan-out cone. However, cells C and H may be modified together because they are not. A conventional ECO tool that uses a timing path basis, may obtain accurate timing through the path A-E-H. However, if that conventional ECO tool made a change to cell E based on that path, the path A-E-I may be adversely affected and the conventional ECO tool would not have that timing information until the timer was updated. If there were adverse effects, the change may have to be undone, wasting valuable design time. Thus, excluding cells that are in another cell's fan-in/fan-out cone may effectively reduce or limit the unintended timing errors that may otherwise be induced by swapping cells in each other's logic cones. In addition, rerunning the STA after each timing path fix in a conventional system may be very time consuming.

As each cell is analyzed, a determination may be made as to whether a given cell can be swapped out (block 135). If the cell is not going to be swapped, the next cell in the list is analyzed as described above in block 130. However, if the cell is going to be swapped, it is swapped with an appropriate cell in the library (block 140).

If there are cells remaining to be fixed (block 145), operation proceeds as described above in conjunction with the description of block 125. However, if there are no cells remaining in the ECO list, the timer may be updated by performing another static timing analysis (block 150) to determine whether there are any timing violations remaining, or whether there are any other types of uncorrected problems remaining. This process may be repeated as many times as is necessary or desired to fix remaining timing violations, or power constraints or any number of other design parameters.

As mentioned above, using timing points and a blacklisted list of cells to fix timing violations and other circuit issues may be faster and may reduce unwanted interactions between related cells when contrasted with simply using timing paths when compared to a conventional ECO tool. In addition, a priority cell list that may optimize based upon different metrics such as downstream power cost may not be available to conventional ECO tools.

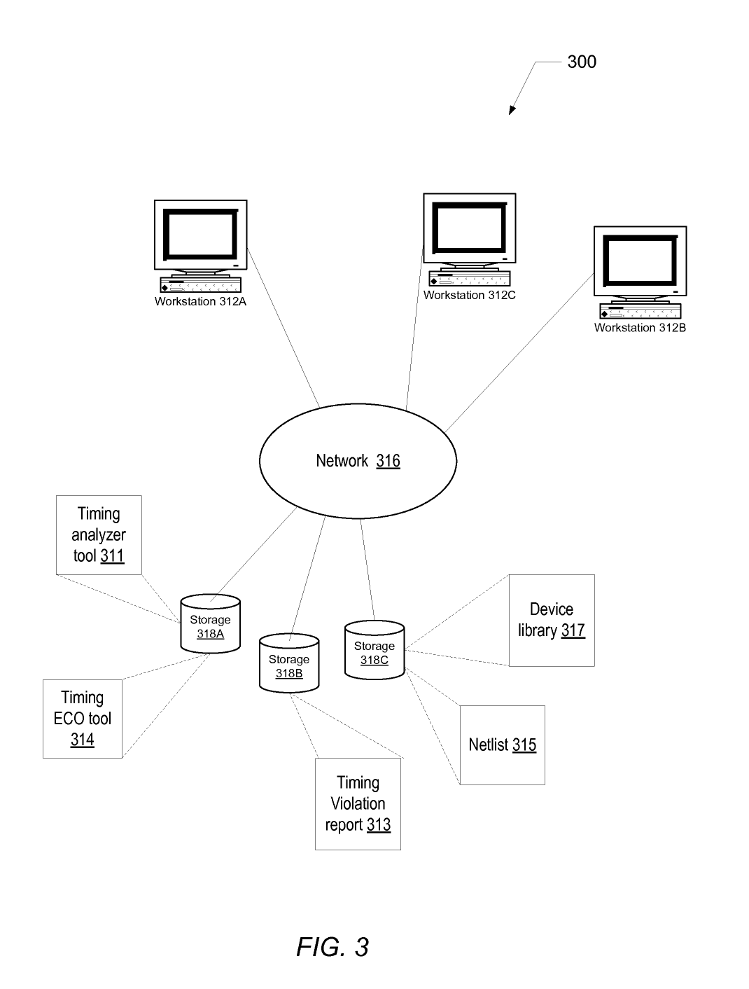

In one embodiment, the ECO design flow described above may be performed manually on a computer by a user. In various other embodiments, the design tools and specifically the ECO design tool may comprise program instructions that may be written in any programming or scripting language and may perform the operations described above in an automated fashion such that once a user provides initial setup and configuration and initiates execution of the program instructions, one or more portions of the tools may be run without further intervention. The ECO design tool and the other EDA tools may comprise program instructions that execute on one or more processors of a computer system. As such, a block diagram of one embodiment of a computer system that may be used to implement the design tools is shown in FIG. 3.

Turning to FIG. 3, computer system 300 includes a plurality of workstations designated 312A through 312C. The workstations are coupled together through a network 316 and to a plurality of storages designated 318A through 318C. In one embodiment, each of workstations 312A-312C may be representative of any standalone computing platform that may include, for example, one or more processors, local system memory including any type of random access memory (RAM) device, monitor, input output (I/O) means such as a network connection, mouse, keyboard, monitor, and the like (many of which are not shown for simplicity).

In one embodiment, storages 318A-318C may be representative of any type of mass storage device such as hard disk systems, optical media drives, tape drives, ram disk storage, and the like. As such, the program instructions comprising the design tools may be stored within any of storages 318A-318C and loaded into the local system memory of any of the workstations during execution. As an example, as shown in FIG. 3, the timing analyzer tool 311 and the ECO tool 314 are shown stored within storage 318A, while the netlist 315 and the device library 317 are stored within storage 318C. Further, the timing violation report 313 is stored within storage 318B. Additionally, the program instructions may be stored on a portable/removable storage media. The program instructions may be executed directly from the removable media or transferred to the local system memory or mass storages 318 for subsequent execution. As such, the portable storage media, the local system memory, and the mass storages may be referred to as non-transitory computer readable storage mediums. The program instructions may be executed by the one or more processors on a given workstation or they may be executed in a distributed fashion among the workstations, as desired.

In one embodiment, the ECO tool 314 may be used to make changes to an IC design based upon information provided by a timing analysis tool 311 or from the device library as described above. In one embodiment, ECO tool 314 may include program instructions written in any of a variety of programming languages or scripting languages, and which may be executable by a processor to perform the above tasks.

It is noted that although the computer system shown in FIG. 3 is a networked computer system, it is contemplated that in other embodiments, each workstation may also include local mass storage. In such embodiments, the program instructions and the results of the design tools may be stored locally. Further, it is contemplated that the program instructions may be executed on a standalone computer such as a personal computer that includes local mass storage and a system memory.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for automatically implementing engineering change order (ECO) corrections in an integrated circuit (IC), the method comprising:
a design tool performing a timing analysis for a netlist of the IC, wherein the netlist includes a listing of device cells;
annotating each of the device cells in the listing with a worst timing slack through a respective timing point associated with the device cell;
generating an ECO list of device cells needing ECO correction;
prioritizing ECO correction order of the device cells in the ECO list based upon cell attributes;
excluding one or more device cells in the ECO list based upon the fan-in or fan-out connection path of other device cells in the ECO list that will be corrected; and
the design tool selecting device cells in the ECO list and replacing the selected device cells in the netlist with different device cells from a design library.

2. The method as recited in claim 1, further comprising excluding one or more device cells in the ECO list if the one or more device cells are connected in the fan-in or fan-out connection path of other device cells in the ECO list that will be corrected.

3. The method as recited in claim 1, further comprising performing an additional timing analysis after the device cells in the ECO list that can be replaced have been replaced.

4. The method as recited in claim 1, further comprising performing a downstream power analysis during the generating of the ECO list, wherein the downstream power analysis includes identifying devices that have one or more fanout paths that include devices that consume power above a predetermined threshold.

5. The method as recited in claim 4, further comprising replacing devices that have one or more fanout paths that include devices that consume power above the predetermined threshold with a device that has a faster switching speed, and replacing one or more of the devices in the one or more fanout paths with devices that have a slower switching speed.

6. The method as recited in claim 1, further comprising performing an upstream power analysis during the generating of the ECO list, wherein the upstream power analysis includes identifying devices that have one or more fan-in paths that include devices that consume power above a predetermined threshold.

7. The method as recited in claim 6, further comprising replacing devices that have one or more fan-in paths that include devices that consume power above the predetermined threshold with a device that has a faster switching speed, and replacing one or more of the devices in the one or more fan-in paths with devices that have a slower switching speed.

8. A system for automatically implementing engineering change order (ECO) corrections in an integrated circuit (IC), the system comprising:
a processor; and
a memory coupled to the processor and configured to store program instructions;
wherein the processor is configured to execute the program instructions to:
perform a timing analysis for a netlist of the IC, wherein the netlist includes a listing of device cells;
annotate each of the device cells in the listing with a worst timing slack through a respective timing point associated with the device cell;
generate an ECO list of device cells needing ECO correction;
prioritize ECO correction order of the device cells in the ECO list based upon cell attributes;
exclude one or more device cells in the ECO list based upon the fan-in or fan-out connection path of other device cells in the ECO list that will be corrected; and
select device cells in the ECO list and replace the selected device cells in the netlist with different device cells from a design library.

9. The system as recited in claim 8, wherein the processor is further configured to execute the program instructions to perform a downstream power analysis during the generating of the ECO list to identify devices that have one or more fanout paths that include devices that consume power above a predetermined threshold.

10. The system as recited in claim 9, the processor is further configured to execute the program instructions to replace devices that have one or more fanout paths that include devices that consume power above the predetermined threshold with a device that has a faster switching speed, and replacing one or more of the devices in the one or more fanout paths with devices that have a slower switching speed.

11. A computer readable storage medium for storing program instructions for implementing engineering change order (ECO) corrections in an integrated circuit (IC), wherein the program instructions are executable by a processor to:
perform a timing analysis for a netlist of the IC, wherein the netlist includes a listing of device cells;
annotate each of the device cells in the listing with a worst timing slack through a respective timing point associated with the device cell;
generate an ECO list of device cells needing ECO correction;
prioritize ECO correction order of the device cells in the ECO list based upon cell attributes;
exclude one or more device cells in the ECO list based upon the fan-in or fan-out connection path of other device cells in the ECO list that will be corrected; and
select device cells in the ECO list and replace the selected device cells in the netlist with different device cells from a design library.

12. The computer readable storage medium as recited in claim 11, wherein the program instructions are further executable by a processor to execute the program instructions to perform a downstream power analysis during the generating of the ECO list to identify devices that have one or more fanout paths that include devices that consume power above a predetermined threshold.

13. The computer readable storage medium as recited in claim 12, wherein the program instructions are further executable by a processor to replace devices that have one or more fanout paths that include devices that consume power above the predetermined threshold with a device that has a faster switching speed, and replacing one or more of the devices in the one or more fanout paths with devices that have a slower switching speed.

14. A method for automatically implementing engineering change order (ECO) corrections in an integrated circuit (IC), the method comprising:
a design tool performing a downstream power analysis and identifying device cells in a netlist of the IC that have one or more fanout paths that consume power above a predetermined threshold;
generating an ECO list of device cells needing ECO correction based upon the downstream power analysis;
prioritizing ECO correction order of the device cells in the ECO list based upon cell attributes;
excluding one or more device cells in the ECO list based upon the fan-in or fan-out connection path of other device cells in the ECO list that will be corrected;
the design tool replacing the device cells in the netlist that have one or more fanout paths that consume power above the predetermined threshold with different device cells from a design library that have a faster switching speed; and
the design tool replacing one or more of the devices in the one or more fanout paths with devices that have a slower switching speed.

15. The method as recited in claim 14, further comprising the design tool performing a timing analysis on the netlist subsequent to replacing device cells in the ECO list that can be replaced.

16. The method as recited in claim 14, further comprising excluding one or more device cells in the ECO list if the one or more device cells are connected in the fan-in or fan-out connection path of other device cells in the ECO list that will be corrected.

17. A computer readable storage medium for storing program instructions for implementing engineering change order (ECO) corrections in an integrated circuit (IC), wherein the program instructions are executable by a processor to:
perform a downstream power analysis and identifying device cells in a netlist of the IC that have one or more fanout paths that consume power above a predetermined threshold;
generate an ECO list of device cells needing ECO correction based upon the downstream power analysis;
prioritize ECO correction order of the device cells in the ECO list based upon cell attributes;
exclude one or more device cells in the ECO list based upon the fan-in or fan-out connection path of other device cells in the ECO list that will be corrected;
replace the device cells in the netlist that have one or more fanout paths that consume power above the predetermined threshold with different device cells from a design library that have a faster switching speed; and
replace one or more of the devices in the one or more fanout paths with devices that have a slower switching speed.

18. The computer readable storage medium as recited in claim 17, wherein the program instructions are further executable by a processor to perform a timing analysis on the netlist subsequent to replacing device cells in the ECO list that can be replaced.

19. The computer readable storage medium as recited in claim 17, wherein the program instructions are further executable by a processor to exclude one or more device cells in the ECO list if the one or more device cells are connected in the fan-in or fan-out connection path of other device cells in the ECO list that will be corrected.

20. A method for automatically implementing engineering change order (ECO) corrections in an integrated circuit (IC), the method comprising:
a design tool performing a timing analysis on a netlist of the IC, wherein the netlist includes a listing of device cells;
generating an ECO list of device cells needing ECO correction based upon the timing analysis;
prioritizing ECO correction order of the device cells in the ECO list based upon cell attributes;
excluding one or more device cells in the ECO list based upon the fan-in or fan-out connection path of other device cells in the ECO list that will be corrected; and
the design tool selecting device cells in the ECO list and replacing the selected device cells in the netlist with different device cells from a design library.

21. The method as recited in claim 20, wherein the cell attributes include device size.

22. The method as recited in claim 20, further comprising performing an additional timing analysis subsequent to the device cells in the ECO list that can be replaced being replaced.
